(19) United States
(12) Patent Application Publication
(10) Pub. No.: US 2005/0102897 A1
(43) Pub. Date: May 19, 2005

(54) Plant container and method for making a plant container

(75) Inventors: Gary L. Vollers, Northridge, CA (US); Don T. Uchiyama, Downey, CA (US)

Correspondence Address: HAHN LOESER & PARKS, LLP, One GOJO Plaza, Suite 300, AKRON, OH, 44311-1076, US

(73) Assignee: Productivity California, Inc.

(21) Appl. No.: 10/997,197

(22) Filed: Nov. 24, 2004

Related U.S. Application Data
(63) Continuation-in-part of application No. 10/361,118, filed on Feb. 10, 2003.

(51) Int. Cl. A01G 9/02

(52) U.S. Cl. 47/66.1

(57) ABSTRACT

A plant container having a cylindrical sidewall with an open top, an open bottom, and a plurality of spaced apart notches formed in a lower edge thereof; and a circular bottom positioned within the cylindrical sidewall open bottom, the circular bottom has a plurality of drain holes therein, the circular bottom is spaced a predetermined distance from the lower edge of the cylindrical sidewall. Both the sidewall and the bottom are preferably formed from a roll of heat sealable polymeric material, such as polyethylene. The sidewall is formed into a tapered cylinder with a sealed overlapping seam. The bottom is positioned near the lower edge of the tapered cylinder and is heat sealed to the sidewall.

This application is a continuation-in-part of co-pending application Ser. No. 10/361,118, filed Feb. 10, 2003.

### BACKGROUND OF THE INVENTION

This invention relates generally to plant containers and a method of making the plant containers and more particularly to two part polymeric plant containers.

### SUMMARY OF THE INVENTION

In one aspect of the present invention, this is accomplished by providing a plant container comprising: a cylindrical sidewall having an open top, an open bottom, and a plurality of spaced apart notches formed in a lower edge thereof; and a circular bottom positioned within the cylindrical sidewall open bottom, the circular bottom having a plurality of drain holes therein, the circular bottom being spaced a predetermined distance from the lower edge of the cylindrical sidewall.

In another aspect of the present invention, this is accomplished by providing a plant container comprising: a tapered cylinder having an open top and an open bottom, the tapered cylinder having a plurality of spaced apart notches formed in a lower edge thereof, and a circular base having a downwardly extending annular rim, the circular base being inserted into the open bottom of the tapered cylinder, the circular base having a plurality of drain holes therein and a plurality of spaced apart notches formed in circular base annular rim, the circular base notches corresponding in position with the tapered cylinder notches.

In another aspect of the present invention, this is accomplished by providing a plant container comprising: a sidewall having a top edge, a bottom edge, two side edges and a plurality of spaced apart apertures proximate the bottom edge, the sidewall being formed into an open container with the side edges overlapping one another; and a flat bottom attached to the sidewall, the flat bottom having a plurality of drain holes therein and a plurality of notches in an outer periphery thereof, the flat bottom being formed into a saucer shape with a portion of an outer part of the flat bottom forming a skirt extending downward from a central portion of the flat bottom, the plurality of notches being in the skirt and the notches being in at least partially overlapping alignment with the apertures.

In another aspect of the present invention, this is accomplished by providing a method of forming a plant container comprising the steps of: providing a first flat sheet material; cutting a plurality of spaced apart apertures in the first flat sheet material; cutting an arcuate piece from the first flat sheet material, the arcuate piece having a curved upper edge, a curved lower edge and two side edges, the spaced apart apertures being proximate the curved lower edge; providing a second flat sheet material; cutting a plurality of drain holes and a plurality of spaced apart notches in the second flat sheet material; cutting a circular piece from the second flat sheet material, the plurality of drain holes being in a central portion of the circular piece, the plurality of spaced apart notches being proximate an outer periphery of the circular piece; forming the arcuate piece into a tapered cylinder with the side edges overlapping one another; attaching an inner surface of one arcuate piece side edge to an outer surface of the other arcuate piece side edge; forming the circular piece into a saucer with an outer circumferential portion forming a skirt extending from a central portion of the circular piece, the notches being in the skirt; placing the saucer into the tapered cylinder with the notches being in at least partially overlapping alignment with the apertures; and attaching the skirt to the tapered cylinder.

In another aspect of the present invention, this is accomplished by providing a method of forming a plant container comprising the steps of: providing a first flat sheet material; cutting a plurality of spaced apart apertures in the first flat sheet material; cutting a sidewall piece from the first flat sheet material, the sidewall piece having an upper edge, a lower edge and two side edges, the spaced apart apertures being proximate the lower edge; providing a second flat sheet material; cutting a plurality of drain holes and a plurality of spaced apart notches in the second flat sheet material; cutting a bottom piece from the second flat sheet material, the plurality of drain holes being in a central portion of the bottom piece, the plurality of spaced apart notches being proximate an outer periphery of the bottom piece; forming the sidewall piece into an open container with the side edges overlapping one another; attaching an inner surface of one sidewall side edge to an outer surface of the sidewall other side edge; forming the bottom piece into a saucer with an outer peripheral portion forming a skirt extending from a central portion of the bottom piece, the notches being in the skirt; placing the saucer into the open container with the notches being in at least partially overlapping alignment with the apertures; and attaching the skirt to the open container, thereby forming a closed bottom container.

The foregoing and other aspects will become apparent from the following detailed description of the invention when considered in conjunction with the accompanying drawing figures.

### BRIEF DESCRIPTION OF THE DRAWING FIGURES

FIG. 1 is a perspective view of a plant container according to the present invention;

FIG. 2 is a plan view of a first embodiment of a sidewall for the plant container shown in FIG. 1;

FIG. 2A is a plan view of the sidewall shown in FIG. 2, illustrating one step in the formation of the sidewall;

FIG. 3 is a plan view of a second embodiment of a sidewall for the plant container shown in FIG. 1;

FIG. 4 is a plan view of a bottom piece for the plant container shown in FIG. 1;

FIG. 4A is a plan view of the bottom piece shown in FIG. 4, illustrating one step in the formation of the bottom piece;

FIG. 5 is a perspective view of the bottom piece shown in FIG. 4, showing the skirt extending in a downward direction;

FIG. 6 is a partial cross-sectional view of the attachment of the bottom piece with the sidewall shown in FIG. 2; and

FIG. 7 is a partial cross-sectional view of the attachment of the bottom piece with the sidewall shown in FIG. 3.

### DETAILED DESCRIPTION

An embodiment of the plant container 10 shown in the FIGURES is formed from a sidewall 21 and a bottom 41. The sidewall 21 is formed into a tapered cylinder with an open top and an open bottom. Side edges 26, 28 form an overlapping seam 14. Preferably, sidewall 21 is formed from a heat sealable material and the side edges 26, 28 are heat sealed to form seam 14. More preferable, sidewall 21 is formed from a heat sealable polymeric material, and most preferably is formed from polyethylene.

Plant container 10 has a plurality of apertures 30 formed in the lower edge of the sidewall 21. In addition, bottom 41 includes a plurality of drain holes 42 and is positioned a predetermined distance from the lower edge 24 of sidewall 21. The combination of the bottom 41 being positioned above the bottom edge 24 and the apertures 30 permits water to drain away from the interior of plant container 10 and allows air to enter through apertures 30. This will reduce damage to plant roots caused by retention of excess water in plant container 10.

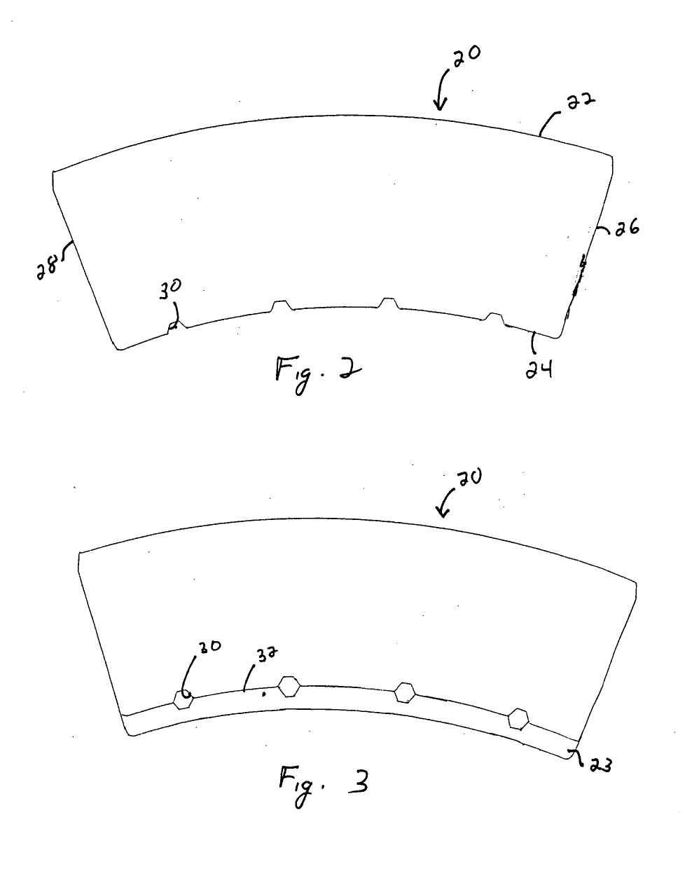

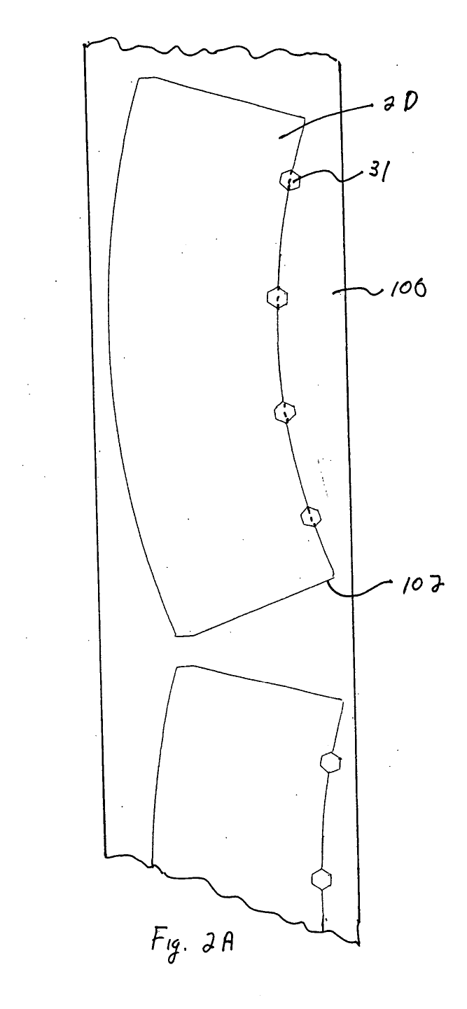

FIGS. 2 and 3 show two embodiments of sidewall blanks 20 used to form sidewall 21. Sidewall blank 20 has an arcuate shape with a curved top or upper edge 22 and a concentric curved bottom or lower edge 24. Extending between the top and bottom edges, 22, 24 are side edges 26, 28. A plurality of apertures 30 are formed in or adjacent to lower edge 24. In the embodiment shown in FIG. 2, the apertures 30 are formed in lower edge 24.

In the embodiment shown in FIG. 3, the apertures 30 are spaced slightly from lower edge 24. A score line 32 extending through the apertures is formed in the sidewall blank 20. The area between the score line 32 and the lower edge 24 forms an overlap 23.

FIG. 2A illustrates one step in the formation of sidewall blank 20. Sidewall blank 20 is formed from a web of flat sheet material 100. First, a plurality of holes 31 are formed in web 100. Sidewall cut line 102 is shown in FIG. 2A to show the relationship of the holes 31 relative to the outline of sidewall blank 20. After holes 31 are cut, web 100 is cut along line 102 to form sidewall blank 20. FIG. 2A illustrates the formation of the sidewall blank 21 shown in FIG. 2. When sidewall blank 20 shown in FIG. 3 is being formed, holes 31 would be spaced further from the lower edge of cut line 102. In addition to cutting sidewall blank 20 from web 102, a score line 32 would also be formed in sidewall blank 20.

In one embodiment, web 100 is polypropylene or polyethylene containing 15% to 20% 300 mesh talc or calcium.

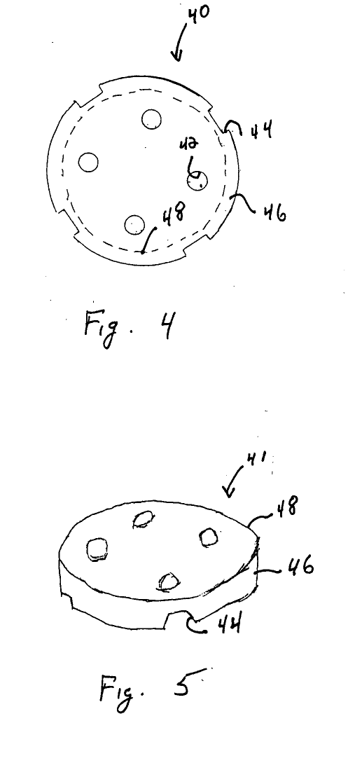

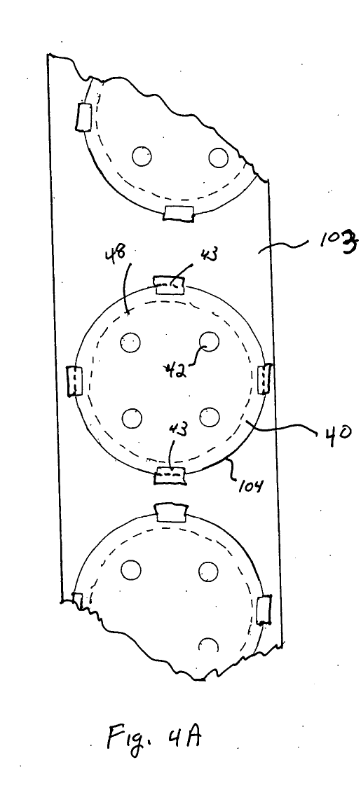

The bottom 41 of plant container 10 is formed from a bottom blank 40, as shown in FIGS. 4 and 5. Preferably, bottom blank 40 is circular having a plurality of drain holes 42 formed in a central portion of the bottom blank 40. An outer peripheral area of the bottom blank 40 forms a skirt 46. A plurality of spaced apart notches 44 are formed in the skirt 46. Preferably, notches 44 correspond in number, size and placement with apertures 30.

FIG. 4A illustrates one step in the formation of bottom blank 40. Bottom blank 40 is formed from a web of flat sheet material 103. First, a plurality of drain holes 42 and holes 43 are formed in web 103. Bottom blank cut line 104 is shown in FIG. 4A to show the relationship of the drain holes 42 and holes 43 relative to the outline of bottom blank 40. Cut line 104 extends through holes 43. After drain holes 42 and holes 43 are cut, web 103 is cut along line 104 to form bottom blank 40. Notches 44 are formed when bottom blank 41 is cut from web 103. After bottom blank 40 is cut from web 103, the bottom blank 40 is pressed into a saucer shape as shown in FIG. 5. Dotted line 48 shows the division between the central portion of bottom blank 40 and the skirt 46. Notches 44 are positioned in a lower edge of skirt 46.

In one embodiment, web 103 is polypropylene or polyethylene containing 40% to 50% 300 mesh talc or calcium.

The thickness of sidewall 21 and bottom 41 can be from 0.005 to 0.030 inches, Preferably, the bottom 41 thickness is 0.010 inches and the sidewall 21 thickness is between 0.016 and 0.020 inches.

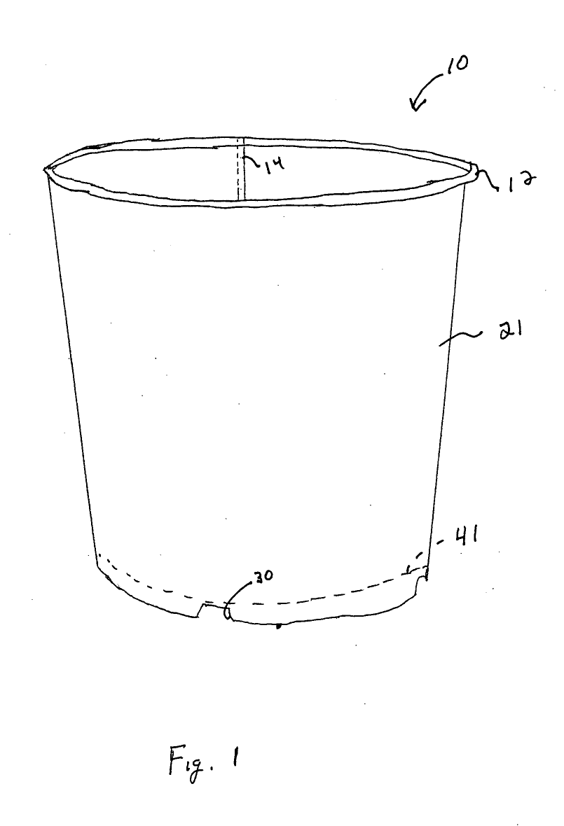

After sidewall blank 20 has been formed from web 100, sidewall blank 20 is formed into a tapered cylinder, as shown in FIG. 1. In one embodiment, an outer surface of one side edge and an inner surface of the other side edge are heated. As the tapered cylinder is formed, the heated surfaces are pressed together to seal the side edges at overlapping seam 14. Similarly, the outer surface of skirt 46 and the inner surface of sidewall blank 20 proximate lower edge 24 are heated. Bottom 41 is positioned within the tapered cylinder and the heated surfaces are pressed together to seal the bottom 41 to the tapered cylinder. As bottom 41 is positioned within the tapered cylinder, notches 44 are aligned to be at least partially overlapping with apertures 30.

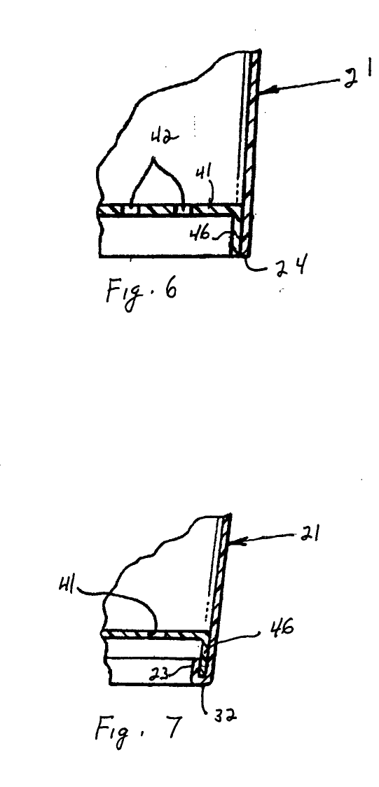

When the sidewall blank 20 shown in FIG. 2 is used, the bottom 41 and the sidewall 21 are aligned as shown in FIG. 6. When the sidewall blank 20 shown in FIG. 3 is used, the bottom 41 and the sidewall 21 are aligned as shown in FIG. 7. As the sidewall blank 20 is formed into the tapered cylinder, the lower portion of the sidewall blank 20 is turned or folded along score line 32 so that bottom skirt 46 fits between the overlapping portion 23 of sidewall blank 20 and the adjacent inner surface of sidewall blank 20 as shown in FIG. 7.

Sidewall blank 20 can have other shapes in addition to the arcuate shape shown in FIGS. 2 and 3. For example, if sidewall blank 20 were rectangular, a non-tapered cylindrical plant container 10 could be formed. Other shapes could be used to form a non-round plant container 10.

To form the tapered cylinder plant container 10 shown in FIG. 1, web 100 is provided, preferably in the form of a roll of heat sealable material. A plurality of spaced apart holes 31 are cut in web 100. Then, an arcuate sidewall blank 20 is cut from web 100 along cut line 102. The lower edge 24 of sidewall blank 20 either extends through holes 31, as shown in FIG. 2, or is proximate holes 31, as shown in FIG. 3.

Web 103 is provided, also preferably in the form of a roll of heat sealable material. A plurality of drain holes 42 and holes 43 are cut in web 103. Bottom blank 40 is cut from web 103 along cut line 104. Next, bottom blank 40 is pressed into bottom 41 forming downwardly extending skirt 46. The steps of forming sidewall blank 20 and bottom 41 may be performed simultaneously depending upon the machines being used.

Side edges 26, 28 of arcuate sidewall blank 20 are then heated. Preferably, the inner surface of one edge and the outer surface of the other edge only are heated. Sidewall blank 20 is then formed into an open tapered cylinder. The heated edges are pressed together to form overlapping seam 14. The upper edge 22 of sidewall blank 20 is rolled to form rolled rim 12.

The inner surface sidewall blank 20 adjacent lower edge 24 and the outer surface edge of skirt 46 are heated. Bottom 41 is inserted into the open lower end of the tapered cylinder. As bottom 41 is inserted into the open lower end of the tapered cylinder, notches 44 are aligned with apertures 30. The lower portion of sidewall 21 and bottom 41 are pressed together to seal bottom 41 and sidewall 21 together. Preferably, bottom 41 is positioned a predetermined distance from the lower edge 24 of sidewall 21.

A machine similar to a PCM1002 or a PMC1300NR by Paper Machinery Corporation can be used to manufacture plant container 10.

1. A plant container comprising:
a cylindrical sidewall having an open top, an open bottom, and a plurality of spaced apart notches formed in a lower edge thereof; and
a circular bottom positioned within the cylindrical sidewall open bottom, the circular bottom having a plurality of drain holes therein, the circular bottom being spaced a predetermined distance from the lower edge of the cylindrical sidewall.

2. The plant container according to claim 1, wherein the cylindrical sidewall notches have a predetermined height, the predetermined distance being at least the same as the predetermined height.

3. The plant container according to claim 1, wherein the circular bottom has a downwardly extending skirt extending from an outer periphery.

4. The plant container according to claim 3, wherein the downwardly extending skirt has a plurality of spaced apart notches formed therein, the circular bottom notches being in at least partially overlapping alignment with the cylindrical sidewall notches.

5. A plant container comprising:
a tapered cylinder having an open top and an open bottom, the tapered cylinder having a plurality of spaced apart notches formed in a lower edge thereof; and
a circular base having a downwardly extending annular rim, the circular base being inserted into the open bottom of the tapered cylinder, the circular base having a plurality of drain holes therein and a plurality of spaced apart notches formed in circular base annular rim, the circular base notches corresponding in position with the tapered cylinder notches.

6. A plant container comprising:
a sidewall having a top edge, a bottom edge, two side edges and a plurality of spaced apart apertures proximate the bottom edge, the sidewall being formed into an open container with the side edges overlapping one another; and
a flat bottom attached to the sidewall, the flat bottom having a plurality of drain holes therein and a plurality of notches in an outer periphery thereof, the flat bottom being formed into a saucer shape with a portion of an outer part of the flat bottom forming a skirt extending downward from a central portion of the flat bottom, the plurality of notches being in the skirt and the notches being in at least partially overlapping alignment with the apertures.

7. The plant container according to claim 6, wherein a lower portion of the sidewall is folded inward in an overlapping relationship with an inside surface of the open container, the flat bottom skirt being between the inside surface of the open container and the overlapping lower portion of the sidewall, a portion of the sidewall apertures being in the overlapping lower portion.

8. The plant container according to claim 7, wherein the sidewall is a heat sealable polymer.

9. The plant container according to claim 6, wherein the plurality of apertures extend to the lower edge of the sidewall.

10. The plant container according to claim 6, wherein the sidewall is arcuate-shaped, the arcuate-shaped sidewall being formed into a tapered cylinder and the flat bottom is circular.

11. A method of forming a plant container comprising the steps of:
providing a first flat sheet material;
cutting a plurality of spaced apart apertures in the first flat sheet material;
cutting an arcuate piece from the first flat sheet material, the arcuate piece having a curved upper edge, a curved lower edge and two side edges, the spaced apart apertures being proximate the curved lower edge;
providing a second flat sheet material;
cutting a plurality of drain holes and a plurality of spaced apart notches in the second flat sheet material;
cutting a circular piece from the second flat sheet material, the plurality of drain holes being in a central portion of the circular piece, the plurality of spaced apart notches being proximate an outer periphery of the circular piece;
forming the arcuate piece into a tapered cylinder with the side edges overlapping one another;
attaching an inner surface of one arcuate piece side edge to an outer surface of the other arcuate piece side edge;
forming the circular piece into a saucer with an outer circumferential portion forming a skirt extending from a central portion of the circular piece, the notches being in the skirt;
placing the saucer into the tapered cylinder with the notches being in at least partially overlapping alignment with the apertures; and
attaching the skirt to the tapered cylinder.

12. The method according to claim 11, wherein the step of providing a first flat sheet material comprises providing a first flat heat sealable polymeric sheet material.

13. The method according to claim 11, wherein the step of cutting an arcuate piece from the first flat sheet material comprises cutting through the plurality of spaced apart apertures such that only a portion of the spaced apart apertures remain in the arcuate piece.

14. A method of forming a plant container comprising the steps of:
providing a first flat sheet material;
cutting a plurality of spaced apart apertures in the first flat sheet material;
cutting a sidewall piece from the first flat sheet material, the sidewall piece having an upper edge, a lower edge and two side edges, the spaced apart apertures being proximate the lower edge;
providing a second flat sheet material;
cutting a plurality of drain holes and a plurality of spaced apart notches in the second flat sheet material;
cutting a bottom piece from the second flat sheet material, the plurality of drain holes being in a central portion of the bottom piece, the plurality of spaced apart notches being proximate an outer periphery of the bottom piece;
forming the sidewall piece into an open container with the side edges overlapping one another;
attaching an inner surface of one sidewall side edge to an outer surface of the sidewall other side edge;
forming the bottom piece into a saucer with an outer peripheral portion forming a skirt extending from a central portion of the bottom piece, the notches being in the skirt;
placing the saucer into the open container with the notches being in at least partially overlapping alignment with the apertures; and
attaching the skirt to the open container, thereby forming a closed bottom container.

15. The method according to claim 14, wherein the step of providing a first flat sheet material comprises providing a first flat heat sealable sheet material.

16. The method according to claim 15, wherein the step of providing a first flat sheet material comprises providing a first flat heat sealable polymeric sheet material.

17. The method according to claim 14, wherein the step of forming the sidewall piece into an open container comprises forming the sidewall piece into a cylinder.

18. The method according to claim 17, wherein the step of forming the sidewall piece into a cylinder comprises forming the sidewall piece into a tapered cylinder.

19. The method according to claim 14, wherein the step of cutting an arcuate piece from the first flat sheet material comprises cutting through the plurality of spaced apart apertures such that only a portion of the spaced apart apertures remain in the arcuate piece.
